(19) United States
(12) Patent Application Publication
(10) Pub. No.: US 2015/0098402 A1
(43) Pub. Date: Apr. 9, 2015

(54) WIRELESS RECEPTION DEVICE, WIRELESS TRANSMISSION DEVICE, WIRELESS COMMUNICATION SYSTEM, PROGRAM, AND INTEGRATED CIRCUIT

(71) Applicant: Sharp Kabushiki Kaisha, Osaka-shi, Osaka (JP)

(72) Inventors: Hiromichi Tomeba, Osaka-shi (JP); Takashi Onodera, Osaka-shi (JP); Alvaro Ruiz Delgado, Osaka-shi (JP); Minoru Kubota, Osaka-shi (JP)

(73) Assignee: Sharp Kabushiki Kaisha, Osaka-shi, Osaka (JP)

(21) Appl. No.: 14/399,990

(22) PCT Filed: May 10, 2013
(86) PCT No.: PCT/JP2013/063154

§ 371 Date: Nov. 10, 2014

(30) Foreign Application Priority Data
May 11, 2012 (JP) 2012-109623

(51) Int. Cl. H04L 5/00; H04B 7/04; H04L 25/02; H04B 7/06

(52) U.S. Cl. CPC H04L 5/0053; H04B 7/0697; H04B 7/0452; H04B 7/0417; H04L 25/0204; H04L 25/0224
USPC 370/329

(57) ABSTRACT

A wireless reception device of the invention is a wireless reception device that includes a terminal antenna unit 401 having a plurality of antennas and that receives wireless signals having undergone nonlinear precoding and spatial multiplexing from a wireless transmission device and includes a channel estimation unit 403 that is configured to estimate a channel state to and from the wireless transmission device and to output channel state information, based on first reference signals, and to estimate the channel state to and from the wireless transmission device and to output specific equivalent channel state information, based on second reference signals having undergone the nonlinear precoding, and a spatial demultiplexing processing unit 415 that is configured to demodulate desired signals from the received wireless signals, based on the specific equivalent channel state information.

### TECHNICAL FIELD

The present invention relates to a technology of carrying out multiuser multiple input multiple output transmission.

### BACKGROUND ART

For wireless communication systems, increase in transmission rate is consistently demanded for provision of multifarious broadband information services. The increase in the transmission rate may be achieved by enlargement in communication bandwidth, whereas available frequency bands are limited and improvement in spectral efficiency is therefore fundamental. As a technology by which the spectral efficiency may considerably be improved, multiple input multiple output (MIMO) technology in which a plurality of transmit receive antennas are used to carry out wireless transmission has attracted attention and has been put into practical use for cellular systems, wireless LAN systems, and the like. Quantity of the improvement in the spectral efficiency that is attained by the MIMO technology is proportional to number of the transmit receive antennas. Number of receive antennas that may be provided in a terminal device, however, is limited. Thus multi user-MIMO (MU-MIMO) in which a plurality of terminal devices connected concurrently are regarded as a virtual large-scale antenna array and in which spatial multiplexing of transmit signals from a base station device to terminal devices is carried out is effective for the improvement in the spectral efficiency.

In the MU-MIMO, the transmit signals to the terminal devices are received as inter-user-interference (IUI) by the terminal devices and it is therefore demanded to curb the IUI. In long term evolution that is employed as one of 3.9th generation mobile wireless communication systems, for instance, linear precoding is employed in which the IUI is curbed by previous multiplication in the base station device of linear filters calculated based on channel state information notified from the terminal devices.

As a method of attaining the MU-MIMO in which further improvement in the spectral efficiency may be expected, a MU-MIMO technology that makes use of nonlinear precoding in which nonlinear processing is performed on a side of the base station device has attracted attention. On condition that remainder (modulo) operation may be carried out in the terminal devices, a perturbation vector having elements of complex numbers (perturbation terms) resulting from multiplication of arbitrary Gauss integers by given real numbers may be added to a transmit signal. Provided that the perturbation vector is appropriately set in accordance with a channel state between the base station device and the plurality of terminal devices, required transmission power may considerably be reduced in comparison with the linear precoding. As methods by which optimum transmission performances may be attained in the nonlinear precoding, vector perturbation (VP) disclosed in NPL 1, Tomlinson Harashima precoding (THP) disclosed in NPL 2, and the like are well known.

The precoding is carried out in accordance with the channel state between the base station device and the terminal devices, and thus accuracy of the precoding greatly depends on accuracy of channel state information (CSI) the base station device may grasp. In a wireless communication system with frequency division duplexing that makes use of different carrier frequencies for downlink transmission and uplink transmission, CSI estimated by the terminal devices may be fed back to the base station device and thus the base station device may grasp the CSI. There is a possibility, however, that an error may be observed between the CSI the base station device may grasp and actual CSI. This will be described briefly with reference to FIG. 10.

FIG. 10 is a sequence chart illustrating communication between the base station device and the terminal devices in which the precoding is carried out. Initially, the base station device transmits to the terminal devices reference signals for estimation of the CSI (step S1). The base station device generates transmit data and a reference signal for demodulation (step S2). The reference signals have been known commonly to the base station device and to the terminal device, and the terminal device may estimate the CSI based on the received reference signals (step S3). In fact, however, noises are invariably applied to the receive signals and an error is thereby observed between the estimated CSI and true CSI. This is called channel estimation error. The terminal devices convert the estimated CSI into information that may be notified to the base station device and notify the base station device (step S4). As the information that may be notified, information in which estimated information is directly quantized into digital information, numbers which indicate codes stated on a code book shared between the base station device and the terminal devices, and the like may be enumerated. The base station device restores the CSI from the notified information, whereas an error is still observed between the restored CSI and the true CSI. This is called quantization error. After that, the precoding is carried out based on the restored CSI (step S5). Given processing delay time (referred to as round trip delay) is produced since the terminal devices estimate the CSI and until the base station device transmits signals through performance of the precoding processing. There is time selectivity for channels, normally, and an error is therefore observed between the CSI that the signals having undergone the precoding propagate and the CSI that the terminal devices estimate. As described above, it is enormously difficult for the base station device to obtain accurate CSI. Hereinbelow, the errors between the CSI the base station device grasps and the actual CSI that are caused by the quantization error and the like will generally be referred to as feedback errors.

NPL 3 discusses a method of reducing degradation in transmission performances due to the feedback errors by estimating anew by the terminal device the channel state information at a point of time when the receive signal having undergone the precoding (step S6) is received by the terminal device (step S7) and by carrying out appropriate channel equalization processing anew on the receive signal based on the channel state information (steps S8, S9). The method disclosed in NPL 3, however, assumes a case in which only one data stream is transmitted to each terminal device and assumes only the linear precoding as the precoding.

### CITATION LIST

### Non Patent Literature

NPL 1: B. M. Hochwald, et. al., “A vector-perturbation technique for near-capacity multiantennamultiuser communication-Part II: Perturbation,” IEEE Trans. Commun., Vol. 53, No. 3, pp. 537-544, March 2005.
NPL 2: M. Joham, et. al., “MMSE approaches to multiuser spatio-temporal Tomlinson-Harashimaprecoding”, Proc. 5th Int. ITG Conf. on Source and Channel Coding, Erlangen, Germany, January 2004.
NPL 3: IEEE 802.11-09/1234r1, “Interference cancellation for downlink MU-MIMO,” Qualcomm, March 2010

### SUMMARY OF INVENTION

### Technical Problem

NPL 3 discusses the method of reducing the degradation in the transmission performances due to the feedback errors by estimating anew by the terminal device the channel state information at a point of time when the receive signal having undergone the precoding is received by the terminal device and by carrying out the appropriate channel equalization processing anew on the receive signal based on the channel state information. In the method disclosed in NPL 3, however, it is impossible to transmit a plurality of data streams to each terminal device and precoding applicable thereto is limited to the linear precoding. In actual fact, namely, any method of reducing the degradation in the transmission performances due to the feedback errors in a case where a plurality of data streams are transmitted to each terminal device and where the nonlinear precoding is carried out has not yet been made known.

The invention has been made in consideration of such circumstances. An object of the invention is to provide a wireless reception device, a wireless transmission device, a wireless communication system, a program, and an integrated circuit by which degradation in transmission performances due to feedback errors may be reduced in the wireless communication system with use of the nonlinear precoding.

### Solution to Problem

(1) In order to achieve the object, the invention takes following measures.

That is, the wireless reception device of the invention is a wireless reception device that includes a plurality of antennas and that receives wireless signals having undergone nonlinear precoding and spatial multiplexing from a wireless transmission device and is characterized by including a channel estimation unit that is configured to estimate a channel state to and from the wireless transmission device and to output channel state information, based on first reference signals, and to estimate the channel state to and from the wireless transmission device and to output specific equivalent channel state information, based on second reference signals having undergone a portion of the nonlinear precoding, a spatial demultiplexing processing unit that is configured to demodulate desired signals from the received wireless signals, based on the specific equivalent channel state information, and a wireless transmitter unit that is configured to transmit the channel state information, estimated based on the first reference signals, to the wireless transmission device.

Thus the desired signals are demodulated from the received wireless signals, based on the specific equivalent channel state information, and it is thereby made possible to reduce the degradation in the transmission performances due to an error caused by the quantization error or the like between the channel state information the wireless transmission device grasps and the channel state information the wireless reception device transmits.

(2) The wireless reception device of the invention is characterized in that the spatial demultiplexing processing unit acquires information indicating prior probabilities for perturbation terms added to transmit data by the nonlinear precoding in the wireless transmission device and calculates soft estimates for the wireless signals based on the acquired information indicating the prior probabilities.

Thus the information indicating the prior probabilities for the perturbation terms added to the transmit data by the nonlinear precoding in the wireless transmission device is acquired and the soft estimates for the wireless signals based on the acquired information indicating the prior probabilities are calculated, so that control in which exploration for the perturbation terms is carried out or omitted in accordance with values of the prior probabilities may be exerted. As a result, throughput may be reduced and efficiency may be promoted.

(3) In the wireless reception device of the invention, the spatial demultiplexing processing unit is characterized by acquiring the information indicating the prior probabilities, based on a quadrant in a complex plane that includes signal candidate points for the transmit data to which the perturbation terms have been added.

Thus the information indicating the prior probabilities is acquired based on the quadrant in the complex plane that includes the signal candidate points for the transmit data to which the perturbation terms have been added, and efficiency of the exploration for the perturbation terms may accordingly be promoted.

(4) In the wireless reception device of the invention, the spatial demultiplexing processing unit is characterized by acquiring the information indicating the prior probabilities, based on control information associated with the prior probabilities notified from the wireless transmission device.

Thus the information indicating the prior probabilities is acquired based on the control information notified from the wireless transmission device and associated with the prior probabilities, so that the control in which the exploration for the perturbation terms is carried out or omitted in accordance with the values of the prior probabilities may be exerted. As a result, the throughput may be reduced and the efficiency may be promoted.

(5) In the wireless reception device of the invention, the spatial demultiplexing processing unit is characterized by determining the order of the calculation of the soft estimates for the transmit data, based on the information indicating the prior probabilities for the perturbation terms.

Thus the order of the calculation of the soft estimates for the transmit data is determined based on the information indicating the prior probabilities for the perturbation terms, and the wireless reception device is therefore capable of acquiring the transmit data destined for the wireless reception device, upon notification from the wireless transmission device of antenna port numbers that are used.

(6) In the wireless reception device of the invention, the spatial demultiplexing processing unit is characterized by performing spatial filtering in which receive signal vector is multiplied by the linear filter calculated based on the specific equivalent channel state information and by demodulating the desired signals from the received wireless signals.

Thus the spatial filtering in which the receive signal vector is multiplied by the linear filter calculated based on the specific equivalent channel state information is performed, so that the desired signals may be demodulated in simplest manner.

(7) The wireless transmission device of the invention is a wireless transmission device that includes a plurality of antennas and that transmits data signals destined for a plurality of wireless reception devices while applying spatial multiplexing to the data signals and is characterized by including a channel state information acquisition unit that is configured to acquire from each of the wireless reception devices channel state information generated in each of the wireless reception devices based on first reference signals transmitted to each of the wireless reception devices, precoding units that are configured to apply nonlinear precoding to the data signals, based on the acquired channel state information and to apply a portion of the nonlinear precoding to second reference signals, and a wireless transmitter unit that is configured to transmit the data signals, the first reference signals, and the second reference signals to each of the wireless reception devices.

Thus the second reference signals and the data signals that have undergone the nonlinear precoding are transmitted to each of the wireless reception devices and the wireless reception devices estimate channel states to and from the wireless transmission device, based on the second reference signals having undergone the nonlinear precoding, and demodulate the desired signals from the received wireless signals, based on the specific equivalent channel state information, so that it is made possible to reduce the degradation in the transmission performances due to an error caused by the quantization error or the like between the channel state information the wireless transmission device grasps and the channel state information the wireless reception devices transmit.

(8) The wireless transmission device of the invention is characterized by further including a control information generator unit that is configured to generate the control information indicating the prior probabilities for the perturbation terms which are added to the data signals by the nonlinear precoding and in that the wireless transmitter unit transmits the control information indicating the prior probabilities to each of the wireless reception devices.

Thus the control information generator unit that is configured to generate the control information indicating the prior probabilities for the perturbation terms which are added to the data signals by the nonlinear precoding is further provided, and the wireless transmitter unit transmits the control information indicating the prior probabilities to each of the wireless reception devices, so that the control in which the exploration for the perturbation terms is carried out or omitted in accordance with the values of the prior probabilities may be exerted in the wireless reception devices. As a result, the throughput may be reduced and the efficiency may be promoted.

(9) The wireless communication system of the invention is characterized by including a plurality of the wireless reception devices according to (1) and the wireless transmission device according to (7).

In this configuration, the desired signals are demodulated from the received wireless signals, based on the specific equivalent channel state information, and it is thereby made possible to reduce the degradation in the transmission performances due to the error caused by the quantization error or the like between the channel state information the wireless transmission device grasps and the channel state information the wireless reception devices transmit.

(10) Programs of the invention are programs for a wireless reception device that includes a plurality of antennas and that receives wireless signals having undergone the nonlinear precoding and the spatial multiplexing from a wireless transmission device and are characterized by making a computer execute a series of processing including processing of estimating a channel state to and from the wireless transmission device and outputting channel state information, based on first reference signals, processing of estimating the channel state to and from the wireless transmission device and outputting specific equivalent channel state information, based on second reference signals having undergone a portion of the nonlinear precoding, and processing of demodulating desired signals from the received wireless signals, based on the specific equivalent channel state information.

Thus the desired signals are demodulated from the received wireless signals, based on the specific equivalent channel state information, and it is thereby made possible to reduce the degradation in the transmission performances due to an error caused by the quantization error or the like between the channel state information the wireless transmission device grasps and the channel state information the wireless reception device transmits.

(11) Programs of the invention are programs for a wireless transmission device that includes a plurality of antennas and that transmits data signals destined for a plurality of wireless reception devices while applying the spatial multiplexing to the data signals and are characterized by making a computer execute a series of processing including processing of acquiring from each of the wireless reception devices channel state information generated in each of the wireless reception devices based on first reference signals transmitted to each of the wireless reception devices, processing of applying the nonlinear precoding to the data signals, based on the acquired channel state information, processing of applying a portion of the nonlinear precoding to second reference signals, and processing of transmitting the data signals, the first reference signals, and the second reference signals to each of the wireless reception devices.

Thus the second reference signals and the data signals that have undergone the nonlinear precoding are transmitted to each of the wireless reception devices and the wireless reception devices estimate channel states to and from the wireless transmission device, based on the second reference signals having undergone the nonlinear precoding, and demodulate desired signals from the received wireless signals, based on the specific equivalent channel state information, so that it is made possible to reduce the degradation in the transmission performances due to an error caused by the quantization error or the like between the channel state information the wireless transmission device grasps and the channel state information the wireless reception devices transmit.

(12) The integrated circuit of the invention is an integrated circuit that is mounted in a wireless reception device which includes a plurality of antennas and which receives wireless signals having undergone the nonlinear precoding and the spatial multiplexing from a wireless transmission device and that thereby makes the wireless reception device perform a plurality of functions, and is characterized by making the wireless reception device perform a series of functions including a function of estimating a channel state to and from the wireless transmission device and outputting channel state information, based on first reference signals, a function of estimating the channel state to and from the wireless transmission device and outputting specific equivalent channel state information, based on second reference signals having undergone a portion of the nonlinear precoding, and a function of demodulating desired signals from the received wireless signals, based on the specific equivalent channel state information.

Thus the desired signals are demodulated from the received wireless signals, based on the specific equivalent channel state information, and it is thereby made possible to reduce the degradation in the transmission performances due to an error caused by the quantization error or the like between the channel state information the wireless transmission device grasps and the channel state information the wireless reception device transmits.

(13) An integrated circuit of the invention is an integrated circuit that is mounted in a wireless transmission device which includes a plurality of antennas and which transmits data signals destined for a plurality of wireless reception devices while applying the spatial multiplexing to the data signals and that thereby makes the wireless transmission device perform a plurality of functions and is characterized by making the wireless transmission device perform a series of functions including a function of acquiring from each of the wireless reception devices channel state information generated in each of the wireless reception devices based on first reference signals transmitted to each of the wireless reception devices, a function of applying the nonlinear precoding to the data signals, based on the acquired channel state information, a function of applying a portion of the nonlinear precoding to second reference signals, and a function of transmitting the data signals, the first reference signals, and the second reference signals to each of the wireless reception devices.

Thus the second reference signals and the data signals that have undergone the nonlinear precoding are transmitted to each of the wireless reception devices and the wireless reception devices estimate channel states to and from the wireless transmission device, based on the second reference signals having undergone the nonlinear precoding, and demodulate desired signals from the received wireless signals, based on specific equivalent channel state information, so that it is made possible to reduce the degradation in the transmission performances due to an error caused by the quantization error or the like between the channel state information the wireless transmission device grasps and the channel state information the wireless reception devices transmit.

### Advantageous Effects of Invention

According to the invention, the degradation in the transmission performances due to the feedback errors can be reduced in the wireless communication system that makes use of the nonlinear precoding, and thus contribution can be made to substantial improvement in the spectral efficiency.

### BRIEF DESCRIPTION OF DRAWINGS

FIG. 1 is a diagram illustrating an outline of a wireless communication system according to a first embodiment of the invention.

FIG. 2 is a block diagram illustrating a configuration of a base station device 1 according to the first embodiment of the invention.

FIG. 3 is a block diagram illustrating a device configuration of a precoding unit 107 according to the first embodiment of the invention.

FIG. 4 is a block diagram illustrating a device configuration of an antenna unit 109 according to the first embodiment of the invention.

FIG. 5 is a block diagram illustrating a configuration of a terminal device according to the first embodiment of the invention.

FIG. 6 is a block diagram illustrating a configuration of a terminal antenna unit 401 according to the first embodiment of the invention.

FIG. 7 is a flow chart illustrating signal processing in a channel compensation unit 407 according to the first embodiment of the invention.

FIG. 8 is a flow chart illustrating signal processing for determining data signals to which perturbation terms are not added that is performed in a perturbation vector exploration unit 203 of the precoding unit 107 according to a second embodiment of the invention.

FIG. 9 is a flow chart illustrating ordering processing for a specific channel matrix Gᵤ in the channel compensation unit 407 according to the second embodiment of the invention.

FIG. 10 is a sequence chart illustrating communication between the base station device 1 and terminal devices in which precoding is carried out.

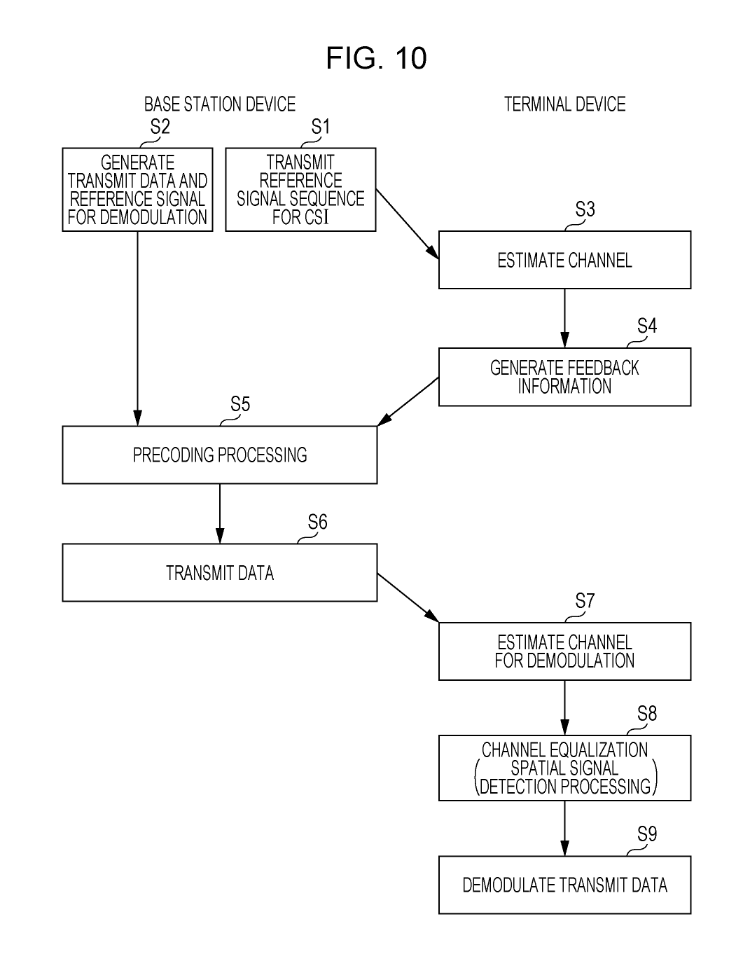

### DESCRIPTION OF EMBODIMENTS

Hereinbelow, embodiments of application of a wireless communication system according to the invention will be described with reference to the drawings. Matters described for the embodiments are each one aspect for understanding of the invention and contents of the invention shall not be interpreted in a manner limited to the embodiments.

Hereinbelow, A^{T} represents transposed matrix of a matrix A, A^{H} represents adjoint (Hermitian transpose) of the matrix A, A⁻¹ represents inverse matrix of the matrix A, A⁺ represents pseudo (or generalized) inverse matrix of the matrix A, diag(A) represents diagonal matrix obtained by extraction of only diagonal components of the matrix A, floor(c) represents a floor function of which real part and imaginary part return maximum Gauss integers not exceeding values of real part and imaginary part, respectively, of a complex number c, E[x] represents ensemble average of a random variable x, abs(c) represents a function that returns amplitude of the complex number c, angle(c) represents a function that returns argument of the complex number c, ∥a∥ represents norm of a vector a, x % y represents remainder of division of an integer x by an integer y, and ₙCₘ represents total number of combinations of m different objects selected from a set of n different objects. [A;B] represents matrix into which two matrices A and B are coupled in row direction and [A,B] represents matrix into which the two matrices A and B are coupled in column direction.

### 1. First Embodiment

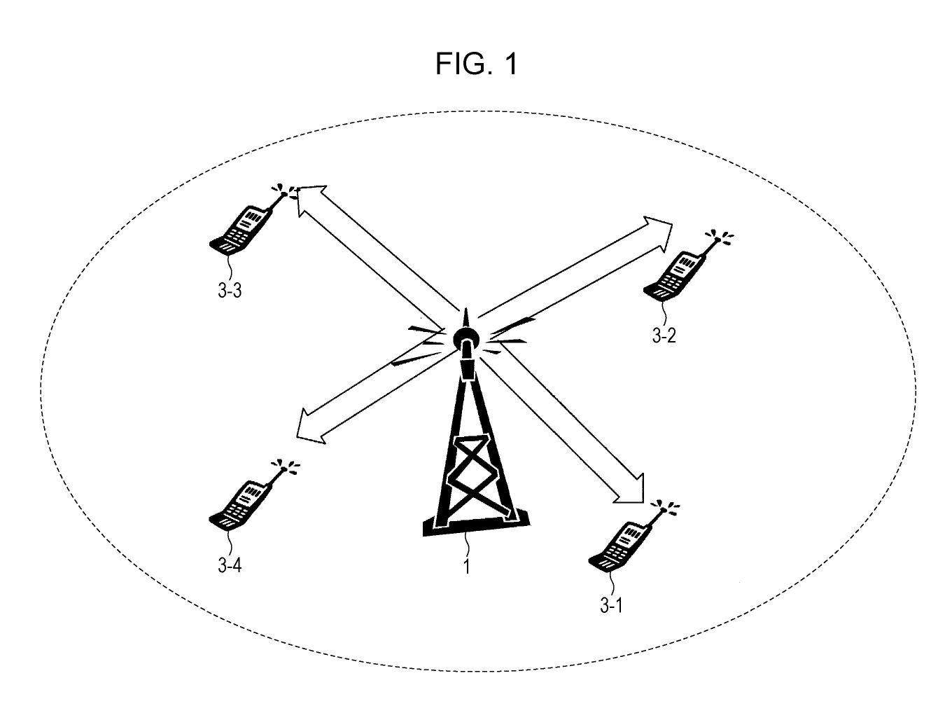

FIG. 1 is a diagram illustrating an outline of a wireless communication system according to a first embodiment of the invention. The first embodiment is intended for MU-MIMO transmission in which U terminal devices 3 (also referred to as wireless reception devices; FIG. 1 illustrates terminal devices 3-1 through 3-4, which will be collectively referred to as terminal devices 3 below) that each have Nᵣ receive antennas are connected to a base station device 1 (also referred to as wireless transmission device) that has Nₜ transmit antennas and that is capable of carrying out nonlinear precoding. L elements of data are simultaneously transmitted to each terminal device 3 (number of elements of data simultaneously transmitted is also referred to as rank). Then equations U×L=Nₜ and L=Nᵣ hold. Though a configuration in which the number of the receive antennas and the rank are the same for all the terminal devices 3 will be described below for simplification, the numbers of the receive antennas and the ranks may differ among the terminal devices 3. The rank does not have to be the same as the number of the receive antennas, as long as expressions U+L≦Nₜ and L≦Nᵣ hold. Orthogonal frequency division multiplexing (OFDM) with sub-carriers numbered in N_{c} is assumed as a transmission scheme. The base station device 1 obtains channel state information to each terminal device 3 from control information notified by the terminal device 3 and carries out precoding for transmit data for each of the sub-carriers based on the channel state information.

Initially, the CSI between the base station device 1 and the terminal devices 3 is defined. In the embodiment, it is assumed that quasi-static frequency selective fading channel is provided. On condition that complex channel gains of k-th sub-carrier between n-th transmit antenna (n=1 through Nₜ) and m-th receive antenna (m=1 through Nᵣ) of u-th terminal device 3-u (u=1 through U) are h_{u,m,n}(k), channel matrix H(k) is defined as Expression (1).

$$\begin{matrix}[ Expression 1 ] & \\ \{ \begin{matrix}H ( k ) = ( \begin{matrix}{h}_{1} ( k ) \\ ⋮ \\ {h}_{U} ( k )\end{matrix} ) \\ {h}_{u} ( k ) = ( \begin{matrix}{h}_{u , 1 , 1} ( k ) & ⋯ & {h}_{u , 1 , {N}_{t}} ( k ) \\ ⋮ & ⋱ & ⋮ \\ {h}_{u , {N}_{r} , 1} & ⋯ & {h}_{u , {N}_{r} , {N}_{t}} ( k )\end{matrix} )\end{matrix} & ( 1 )\end{matrix}$$

wherein hᵤ(k) represents an Nᵣ×Nₜ matrix composed of the complex channel gains observed in the u-th terminal device 3-u. In the embodiment, the CSI refers to a matrix composed of the complex channel gains, unless otherwise specified. A spatial correlation matrix or a matrix with arrangement of filters stated on a codebook, however, may be regarded as the CSI and signal processing that will be described later may be carried out. Thus the CSI the u-th terminal device 3-u estimates is supposed to be hᵤ(k).

### [1.1. Base Station Device 1]

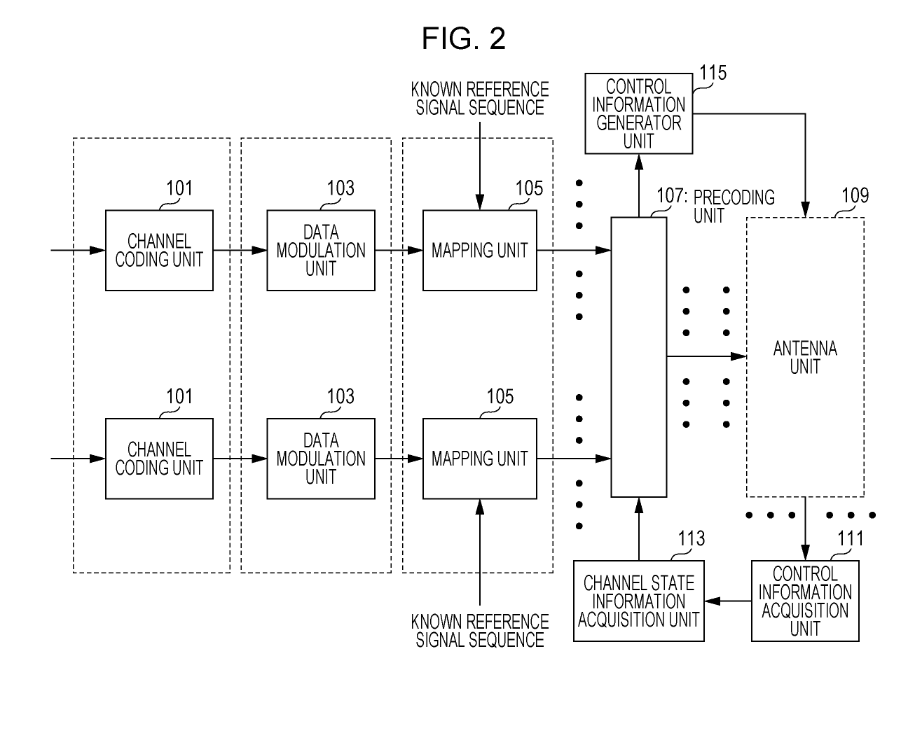

FIG. 2 is a block diagram illustrating a configuration of the base station device 1 according to the first embodiment of the invention. As illustrated in FIG. 2, the base station device 1 includes channel coding units 101, data modulation units 103, mapping units 105, precoding units 107, antenna units 109, a control information acquisition unit 111, a channel state information acquisition unit 113, and a control information generator unit 115. The precoding units 107 number in number N_{c} of the sub-carriers and the antenna units 109 number in the number Nₜ of the transmit antennas. The channel coding units 101 carry out channel coding for transmit data sequences destined for the terminal devices 3 and the data modulation units 103 thereafter carry out digital data modulation such as QPSK and 16QAM. The data modulation units 103 input data signals, having undergone the data modulation, into the mapping units 105.

The mapping units 105 perform mapping (also referred to as scheduling or resource allocation) in which each element of data is placed in a specified wireless resource (also referred to as resource element or simply as resource). Herein, the wireless resources mainly refer to frequency, time, code, and space. The wireless resources that are to be used are determined based on reception quality observed in the terminal devices 3, orthogonality of channels among the terminals that are subjected to the spatial multiplexing, and the like. In the embodiment, the wireless resources that are to be used have been determined in advance and have been recognized by both the base station device 1 and each terminal device 3. The mapping units 105 multiplex known reference signal sequences that are used for channel estimation in the terminal devices 3.

The reference signals destined for the terminal devices 3 are multiplexed so as to be separable in the terminal devices 3 that receive the reference signals and so as to be made orthogonal to one another. Though two sorts of reference signals, namely, CSI-reference signal (CSI-RS) that is reference signal for the channel estimation and demodulation reference signal (DMRS) that is specific reference signal for demodulation are multiplexed as the reference signals, a configuration may be adopted in which another reference signal is further multiplexed thereon. The CSI-RS is for the estimation of the channel matrix observed in each terminal device 3 and the DMRS is for the estimation of the channel state information in which results of precoding that will be described later are reflected. In the invention, the mapping units 105 perform the mapping so that the data signals, the DMRSs, and the CSI-RSs are transmitted at different timing or with different frequencies. The mapping units 105 arrange the CSI-RSs so that the CSI-RSs are orthogonal between the transmit antennas. The mapping units 105 arrange the DMRSs so that the DMRSs are orthogonal between the terminal devices and between associated data streams. The mapping units 105 input data information having undergone the mapping or the like into the precoding units 107 for corresponding sub-carriers.

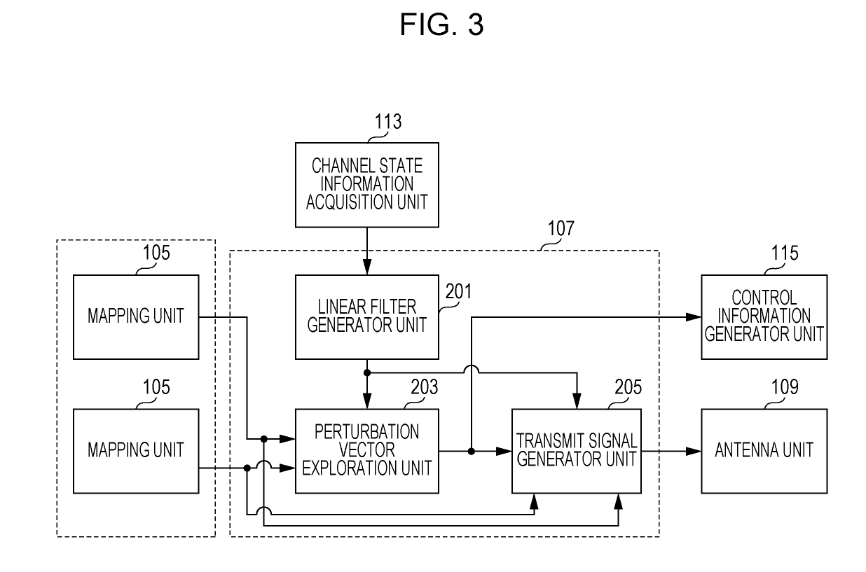

FIG. 3 is a block diagram illustrating a device configuration of the precoding unit 107 according to the first embodiment of the invention. As illustrated in FIG. 3, the precoding unit 107 includes a linear filter generator unit 201, a perturbation vector exploration unit 203, and a transmit signal generator unit 205. To the precoding unit 107, output {dᵤ=[d_{u,1}, . . . , d_{u,L}]^{T}; u=1 through U} of the mapping units 105 that is transmitted on the k-th sub-carrier and that includes the transmit data destined for each terminal device 3 and the channel matrix H(k) for the k-th sub-carrier for output of the channel state information acquisition unit 113 are inputted. In following description, H(k) is ideally acquired in the channel state information acquisition unit 113 and an index k is omitted for simplification.

The precoding unit 107 initially calculates a linear filter W for reduction in the IUI in the linear filter generator unit 201. As for the generated linear filter W, there is no limitation, though it is demanded to consider the simultaneous transmission of the plurality of data to each terminal device 3. Description will be given below on assumption that the linear filter based on block-diagonalization method is calculated.

In each terminal device 3 in the MU-MIMO transmission in which the plurality of data streams are transmitted to each terminal device 3, data signals destined for other terminal devices 3 are received as the IUI and the plurality of data destined for the terminal device 3 itself interfere with one another. This is called inter-antenna-interference (IAI). The linear filter based on the block diagonalization is a filter that curbs only the IUI. Specifically, the linear filter W is a filter that transforms the channel matrix H as in Expression (2).

$$\begin{matrix}[ Expression 2 ] & \\ \begin{matrix}HW = ( \begin{matrix}{h}_{1} \\ ⋮ \\ {h}_{U}\end{matrix} ) ( \begin{matrix}{w}_{1} & ⋯ & {w}_{U}\end{matrix} ) \\ = ( \begin{matrix}{h}_{1} {w}_{1} & 0 & ⋯ & 0 & 0 \\ 0 & {h}_{2} {w}_{2} & ⋯ & 0 & 0 \\ ⋮ & ⋮ & ⋱ & ⋮ & ⋮ \\ 0 & 0 & ⋯ & {h}_{U - 1} {w}_{U - 1} & 0 \\ 0 & 0 & ⋯ & 0 & {h}_{U} {w}_{U}\end{matrix} )\end{matrix} & ( 2 )\end{matrix}$$

wherein {wᵤ;u=1 through U} is an Nₜ×L matrix obtained by extraction from the linear filter W of components by which a transmit data vector dᵤ destined for the u-th terminal device 3-u is multiplied. Hereinbelow, an Nᵣ×L matrix expressed as hᵤwᵤ=Gᵤ will be referred to as specific equivalent channel matrix. When the precoding is actually carried out, the transmit signal is multiplied by a power normalization coefficient β that will be described later. Therefore, βhᵤwᵤ=Gᵤ resulting from further multiplication by β makes the actual specific equivalent channel matrix. The calculation of W may be made based on MMSE criterion that minimizes mean square error between the transmit signal and the receive signal without complete suppression of the IUI.

A transmit signal vector s=Wd is calculated by multiplication of W calculated by the linear filter generator unit 201 and of a transmit data vector d=[d₁^{T}, . . . , d_{U}^{T}]^{T} expressed by arrangement of the transmit data vectors dᵤ destined for the terminal devices 3. In order to make transmission power constant, however, s=βWd resulting from multiplication by the power normalization coefficient β for equalization of power between the transmit data vector d before the precoding and the transmit signal vector s makes the actual transmit signal vector. The power normalization coefficient β is given by Expression (3).

$$\begin{matrix}[ Expression 3 ] & \\ β = \sqrt{\frac{P}{tr ( WE [ {dd}^{H} ] ) {W}^{H} )}} & ( 3 )\end{matrix}$$

wherein P represents total transmission power. A condition of β=1 signifies that the performance of the precoding causes no increase in the required transmission power, and a condition of β<1 signifies that there is an increase in the required transmission power. Relation β=1 holds when the linear filter W is an orthogonal matrix.

It is preferable to make an appropriate combination of the terminal devices 3 subjected to the spatial multiplexing in order that the linear filter W may be an orthogonal matrix, whereas it is desirable not to impose limitations on the combination of the terminal devices 3 because such limitations decrease fairness of communication opportunities for the terminal devices 3. There may be no combinations of the terminal devices 3 that make the linear filter W an orthogonal matrix, on condition that few terminal devices 3 are connected to the base station device 1. As a method of avoiding the increase in the required transmission power, a method in which perturbation terms are added to the transmit data is conceivable. Precoding supposing the addition of the perturbation terms to the transmit data is referred to as nonlinear precoding.

A perturbation term is expressed as a complex number resulting from multiplication of an arbitrary Gauss integer by a predetermined real number 2δ. The perturbation terms may be removed by application of signal processing that is called modulo operation (or remainder operation) to the receive signal in the terminal devices 3. The real number 2δ, referred to as modulo width, may have any value as long as the real number 2δ is shared between the base station device 1 and the terminal devices. The modulo width that optimizes average transmission quality for each modulation technique, however, has already been found. For instance, it is known that δ=2^{1/2} holds in QPSK modulation. Constant reception quality may invariably be kept by exploration of innumerable perturbation terms for a perturbation term that allows the power normalization term β to be maximized and addition of the perturbation term to the transmit data, regardless of the combination of the terminal devices 3. For maximization of the spectral efficiency, the perturbation term that minimizes the required transmission power is to be explored for. Provided that desired spectral efficiency, desired reception quality, or the like is predetermined, however, demands are satisfied by exploration for a perturbation term that allows the desired quality to be attained.

In the embodiment, number of all the transmit data that are subjected to the spatial multiplexing is U×L and a perturbation term may be added to each of the transmit data. It is unrealistic to explore all Gauss integers because the perturbation terms may be selected from arbitrary Gauss integers and because number of combinations of the perturbation terms that may be added to the transmit data under limitation of number of selectable Gauss integers to k is as many as K^{UL}. Therefore, it is demanded to limit number of the combinations that are to be considered by extreme decrease in the number of the selectable Gauss integers, exclusion from exploration candidates of perturbation terms that make the required transmission power have a value equal to or greater than a given value (this method is called sphere encoding), or the like.

In the embodiment, a method of exploring for the perturbation terms is not limited. For instance, the perturbation terms may be explored for based on the sphere encoding. Hereinbelow, description will be given on assumption that the perturbation vector exploration unit 203 has succeeded in exploration for optimum perturbation terms by some sort of method. The perturbation vector exploration unit 203 inputs into the transmit signal generator unit 205 2δzₜ=2δ[z_{t,1}^{T}, . . . , z_{t,U}^{T}]^{T}, z_{t,u}=[z_{t,u,1}, . . . , z_{t,u,L}]^{T} that is optimum combination (perturbation vector) of perturbation terms that has been explored for. Therein, 2δz_{t,u,l} represents a perturbation term that is added to l-th transmit data destined for the u-th terminal device 3-u.

The transmit signal generator unit 205 calculates a transmit signal vector s=βW(d+2δzₜ) based on the linear filter W calculated by the linear filter generator unit 201, the perturbation vector zₜ calculated by the perturbation vector exploration unit 203, and the transmit data vector d. The power normalization term β therein is calculated afresh in consideration of the perturbation vector zₜ.

Though the normalization of the transmit power is carried out for each of the sub-carriers in above description, the normalization of the power may be carried out so that total transmission power for the plurality of sub-carriers and OFDM signals may be made constant. In this case, the exploration for the perturbation vector zₜ may be controlled in consideration of the total required transmission power.

The transmit signal vector calculated by the transmit signal generator unit 205 is inputted as output of the precoding unit 107 into the antenna unit 109. When the CSI-RSs are inputted into the precoding unit 107, the CSI-RSs are not subjected to the precoding processing but only to regulation of the transmit power and is then outputted toward the antenna unit 109. When the DMRSs are inputted, the DMRSs undergo only the multiplication by the linear filter W and do not undergo the addition of the perturbation terms. Then it is demanded to use the power normalization term β that is the same as multiplier for the data signals. Therefore, the DMRSs and the data signals that undergo the precoding may collectively be controlled so that the transmission power may be normalized.

In the method described above, the precoding unit 107 outputs only the transmit signal vector. In the embodiment, the precoding unit 107 may be configured to output control information associated with prior probabilities of the perturbation terms added to the data signals in the precoding unit 107, in addition to the transmit signal vector. As the control information, information in which actually measured probabilities of occurrence of z_{t,u} are quantized, values of z_{t,u} of which the probabilities of occurrence are equal to or greater than a given value, and the like are conceivable. The probabilities of occurrence may be calculated for each quadrant in a complex plane. The information may be 1-bit information that simply indicates whether there is the addition of the perturbation terms. Frequency at which the probabilities of occurrence are calculated is not limited and the probabilities of occurrence may be calculated for each OFDM signal, each signal frame composed of a plurality of OFDM signals, or one code word in the channel coding. Separately from the transmit signal vector, the control information generated in this manner is inputted into wireless transmitter units 305 in the antenna units 109 that will be described later and is transmitted toward each of the terminal devices 3.

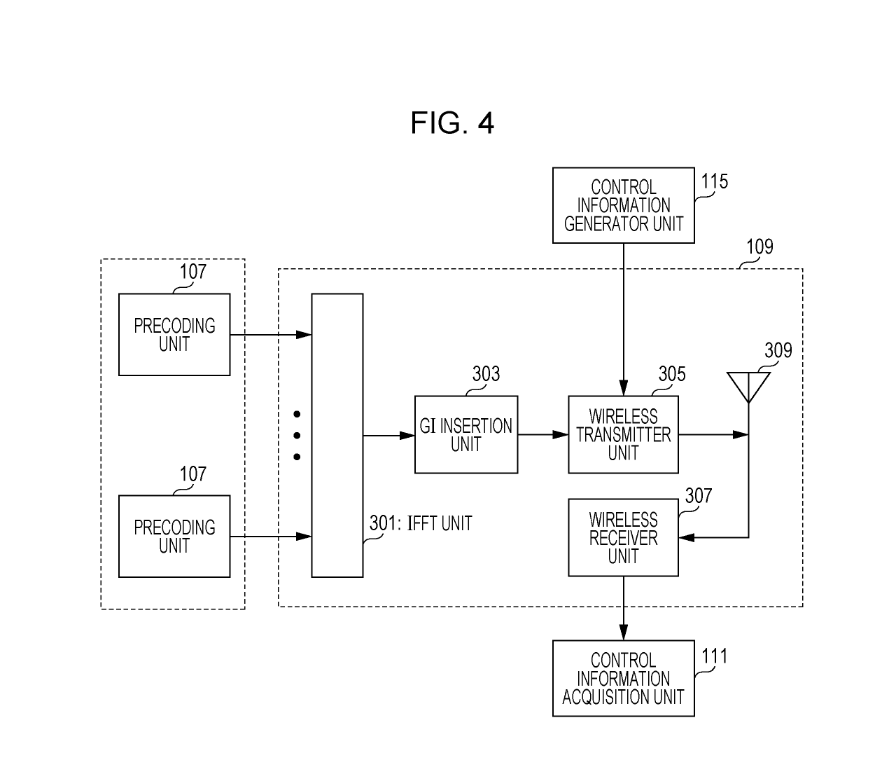

FIG. 4 is a block diagram illustrating a device configuration of the antenna unit 109 according to the first embodiment of the invention. As illustrated in FIG. 4, the antenna unit 109 includes an IFFT unit 301, a GI insertion unit 303, the wireless transmitter unit 305, a wireless receiver unit 307, and an antenna 309. In each antenna unit 109, initially, the IFFT unit 301 applies N_{c}-point inverse fast Fourier transform (IFFT) or inverse discrete Fourier transform (IDFT) to signals outputted from the corresponding precoding unit 107, generates OFDM signals having N_{c} sub-carriers, and inputs the OFDM signals into the GI insertion unit 303. Though description herein is given on assumption that the number of the sub-carriers and number of IFFT points are the same, the number of the points exceeds the number of the sub-carriers on condition that guard bands are configured in a frequency domain. The GI insertion unit 303 provides the inputted OFDM signals with guard intervals and thereafter inputs the OFDM signals into the wireless transmitter unit 305. The wireless transmitter unit 305 converts the inputted transmit signals in baseband range into transmit signals in radio-frequency (RF) range and inputs the transmit signals into the antenna 309. The antenna 309 transmits the inputted transmit signals in the RF range. In the embodiment, information associated with the CSI estimated by the terminal devices 3 is received by the wireless receiver unit 307 and is outputted toward the control information acquisition unit 111.

### [1.2. Terminal Device 3]

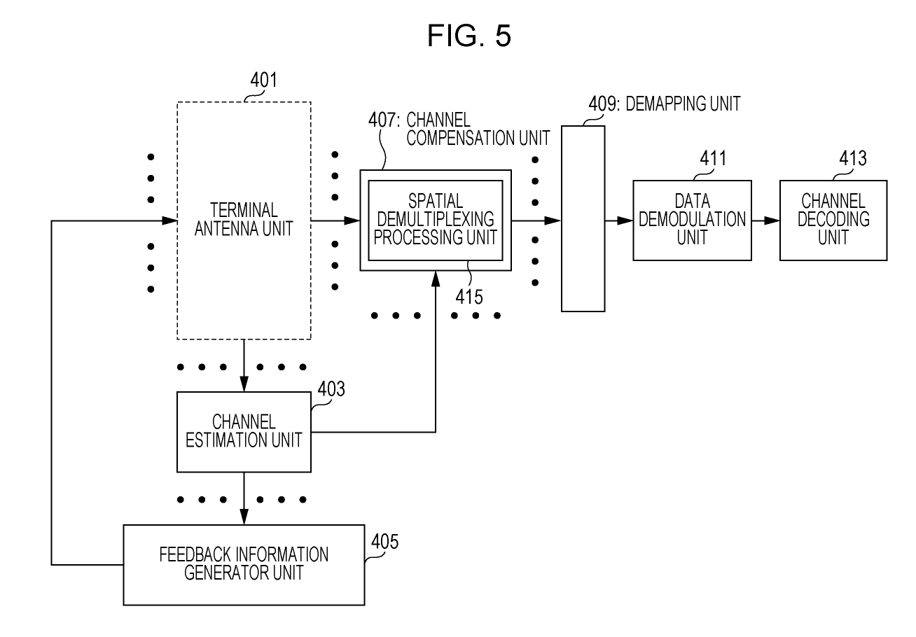

FIG. 5 is a block diagram illustrating a configuration of the terminal device 3 according to the first embodiment of the invention. As illustrated in FIG. 5, the terminal device 3 includes terminal antenna units 401, a channel estimation unit 403, a feedback information generator unit 405, a channel compensation unit 407, a demapping unit 409, a data demodulation unit 411, and a channel decoding unit 413. The terminal antenna units 401 number in the number Nᵣ of the receive antennas. The channel compensation unit 407 includes a spatial demultiplexing processing unit 415.

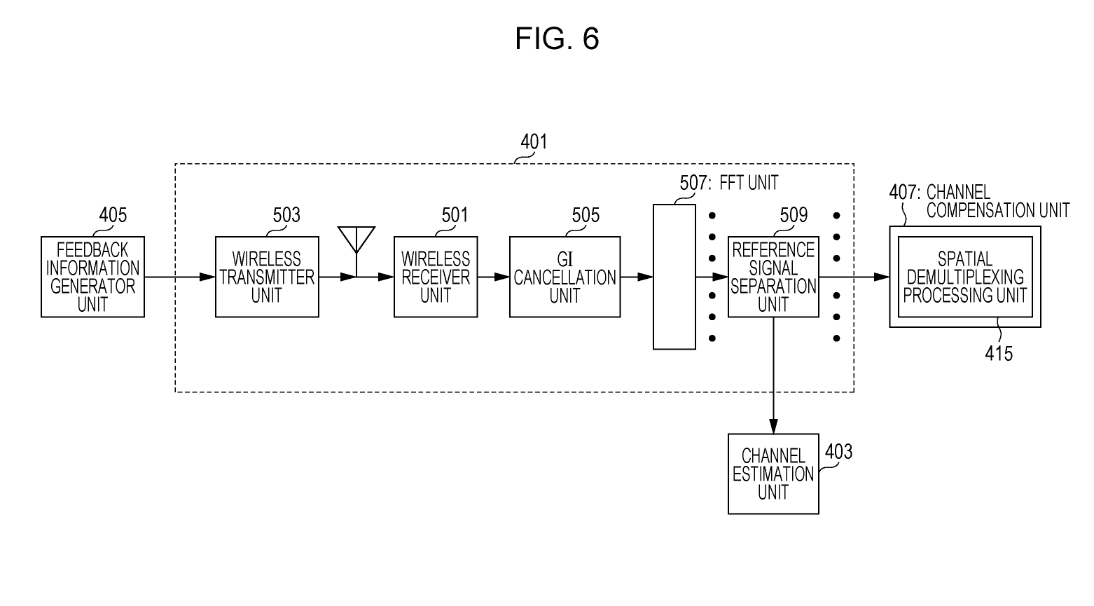

FIG. 6 is a block diagram illustrating a configuration of the terminal antenna unit 401 according to the first embodiment of the invention. As illustrated in FIG. 6, the terminal antenna unit 401 includes a wireless receiver unit 501, a wireless transmitter unit 503, a GI cancellation unit 505, an FFT unit 507, and a reference signal separation unit 509. The transmit signals transmitted from the base station device 1 are initially received by the antenna of each terminal antenna unit 401 and is thereafter inputted into the wireless receiver unit 501. The wireless receiver unit 501 converts the inputted signals into signals in the baseband range and inputs the signals into the GI cancellation unit 505. The GI cancellation unit 505 removes the guard intervals from the inputted signals and inputs the signals into the FFT unit 507. The FFT unit 507 applies N_{c}-point fast Fourier transform (FFT) or discrete Fourier transform (DFT) to the inputted signals, converts the signals into N_{c} sub-carrier components, and inputs the components into the reference signal separation unit 509. The reference signal separation unit 509 separates the inputted signals into data signal components, CSI-RS components, and DMRS components. The reference signal separation unit 509 inputs the data signal components into the channel compensation unit 407 and inputs the CSI-RSs and the DMRSs into the channel estimation unit 403. Signal processing that will be described below is basically carried out for each sub-carrier.

The channel estimation unit 403 carries out channel estimation based on the CSI-RSs and the DMRSs that are inputted known reference signals. Initially, the channel estimation using the CSI-RS will be described. The CSI-RSs are transmitted without application of the precoding and thus the matrix hᵤ(k) corresponding to each terminal device 3 in the channel matrix H(k) represented by Expression (1) may be estimated. Normally, the CSI-RSs are intermittently multiplexed for the wireless resources and directly estimation of the channel state information of all the sub-carriers cannot be attained. Transmission of the CSI-RSs at such time interval and frequency interval as satisfy sampling theorem, however, makes it possible to estimate the channel state information of all the sub-carriers with suitable interpolation. Though there is no special limitation on a specific method for the channel estimation, two-dimensional MMSE channel estimation may be used, for instance.

The channel estimation unit 403 inputs the channel state information, estimated based on the CSI-RSs, into the feedback information generator unit 405. The feedback information generator unit 405 generates information that is to be fed back to the base station device 1 in accordance with the inputted channel state information and channel state information format for feedback from each terminal device 3. In the invention, the channel state information format is not limited. For instance, a method is conceivable in which the estimated channel state information is quantized with finite bit number and in which the quantized information is fed back. The feedback may be performed based on a code book arranged in advance with the base station device 1. Whichever channel state information format is used, however, the error (quantization error) is observed between the channel state information restored from the information fed back and the true channel state information. In particular, decrease in quantization bit rate for purpose of reducing overhead causes increase in influence of the feedback errors. The feedback information generator unit 405 inputs the generated signals into the wireless transmitter unit 503 of the terminal antenna unit 401. The wireless transmitter unit 503 converts the inputted signals into signals suitable for notification to the base station device 1 and inputs the signals into the antenna of the terminal antenna unit 401. The antenna of the terminal antenna unit 401 transmits the inputted signals toward the base station device 1. Channel estimation using DMRS will be described later.

Signal processing in the channel compensation unit 407 will be described below. On condition that the data signal component received by m-th receive antenna of the u-th terminal device 3-u is represented as r_{u,m}, a receive signal vector rᵤ=[r_{u,1}, . . . , r_{u,Nr}]^{T} that may be grasped by the u-th terminal device 3-u is given as Expression (4).

$$\begin{matrix}[ Expression 4 ] & \\ \begin{matrix}{r}_{u} = {h}_{u} s + {η}_{u} \\ = β {h}_{u} W ( d + 2 δ {z}_{t} ) + {η}_{u} \\ = β {h}_{u} {w}_{u} ( {d}_{u} + 2 δ {z}_{t} ) + {η}_{u} \\ = {G}_{u} ( {d}_{u} + 2 δ {z}_{t} ) + {η}_{u}\end{matrix} & ( 4 )\end{matrix}$$

wherein ηᵤ=[η_{u,1}, . . . , η_{u,Nr}]^{T} represents a noise vector. Then an expression βhᵤwᵤ=Gᵤ holds, wherein Gᵤ is the specific equivalent channel matrix that has already been described. That is, the receive signals of the u-th terminal device 3-u may be regarded as signals having been propagated through Nᵣ×L MIMO channels.

Estimation of Gᵤ is demanded for demodulation of desired signals from the receive signals. Gᵤ may be estimated by the channel estimation using DMRS. The DMRSs have been multiplexed so as to be orthogonal between the terminal devices and between the data streams and have not undergone the addition of the perturbation terms. In case where the DMRS is transmitted to l-th data stream of the u-th terminal device 3-u, for instance, the receive signal is given by Expression (5).

[Expression 5]

r_{u,p}=hᵤsₚ+ηᵤ=Gᵤ[0, . . . ,0,p_{u,l},0, . . . ,0]^{T}+ηᵤsₚ=βW[0, . . . ,0,p_{u,l},0, . . . ,0]^{T} (5)

wherein p_{u,l} represents DMRS that is transmitted in l-th place to the u-th terminal device 3-u, and sₚ is a transmit signal vector that is actually transmitted from the base station device 1 when the DMRS is transmitted. Since p_{u,l} has been known by the base station device 1 and the u-th terminal device 3-u, the channel estimation unit 403 is capable of estimating l-th column of Gᵤ. The channel estimation unit 403 further combines all results estimated from other DMRSs and estimates the specific equivalent channel matrix Gᵤ. It is demanded, however, that the DMRSs be orthogonal to one another and be orthogonal to the data signals and the CSI-RSs. This means that direct estimation of Gᵤ of all the sub-carrier components cannot be attained. Correlations in directions of time and frequency normally exist for channels, however, and channels in wireless resources where the DMRSs are not transmitted may be estimated, providing that the DMRSs are periodically transmitted at appropriate intervals. The channel estimation unit 403 inputs Gᵤ estimated based on the DMRSs into the channel compensation unit 407.

The channel compensation unit 407 demodulates desired signals from the receive signals rᵤ, based on the specific equivalent channel matrix Gᵤ estimated with use of the DMRSs as described above. In conventional nonlinear MU-MIMO, the base station device 1 carries out precoding that curbs not only the IUI but also the IAI, that is, precoding that makes the specific equivalent channel matrix a unit matrix. Therefore, mere synchronous detection is sufficient for signal processing that is performed in the channel compensation unit 407 therein. Actual presence of the feedback errors as described above, however, makes the IUI and the IAI remain and substantially degrades the transmission performances. In the embodiment, only the IUI is curbed in the precoding. Accordingly, signal spatial demultiplexing processing is further necessitated in the channel compensation unit 407, in contrast to conventional methods, and complexity of the terminal devices 3 is thereby increased. The remaining IUI and the remaining IAI caused by the feedback errors, however, may be curbed by channel compensation based on the specific equivalent channel matrix Gᵤ estimated with use of the DMRSs.

Reception diversity combining technology has existed as a conventional technology in which this is taken notice of. In this method, rank-1 transmission to each terminal device 3 is performed and the linear precoding is assumed as the precoding. Therefore, the base station device 1 carries out the precoding that completely curbs the IUI on assumption that the number of the receive antennas in each terminal device 3 is one. Each terminal device 3 calculates an appropriate linear filter (linear filter is Nᵣ×1 column vector in this configuration) based on the specific equivalent channel matrix estimated with use of DMRS. Then desired signals are detected by multiplication of receive signals by the linear filter. In this method, the linear filter is based on the specific equivalent channel matrix and influence of the remaining IUI may be curbed by the terminal devices 3. Because the conventional technology, however, is directed to the rank-1 transmission, the remaining IAI produced during multiple rank transmission to which the embodiment is directed cannot be curbed by this method. The channel compensation unit 407 of the terminal device 3 in the embodiment performs signal spatial detection processing in consideration of the remaining IAI, based on the specific equivalent channel matrix Gᵤ, so that nonlinear MU-MIMO transmission by which the influence of the feedback errors may be curbed is attained.

Simplest method for the signal spatial detection processing performed in the channel compensation unit 407 in the embodiment is the spatial filtering. In this method, the receive signal vector rᵤ is multiplied by linear filter Wᵣ calculated based on Gᵤ. A method based on ZF criterion that completely curbs the remaining IAI and a method based on the MMSE criterion that minimizes the mean square error between the transmit signals and the receive signals are conceivable as a method of calculating of the linear filter, which methods are given by Expression (6).

$$\begin{matrix}[ Expression 6 ] & \\ {W}_{r} = \{ \begin{matrix}{( {G}_{u}^{H} G )}^{- 1} {G}^{H} , & ZF \\ {( {G}_{u}^{H} G + {σ}^{2} I )}^{- 1} {G}^{H} , & MMSE\end{matrix} & ( 6 )\end{matrix}$$

wherein σ² is variance of noises applied in the terminal devices 3 and I represents unit matrix. The channel compensation unit 407 outputs signals obtained by multiplication of the receive signal vector by Wᵣ.

The signal spatial detection processing based on the spatial filtering is simple but lacking in consideration of the perturbation terms. Therefore, the transmission performances may be degraded when signal detection based on the MMSE criterion is performed, in particular. Thus the channel compensation unit 407 in the embodiment is configured to be capable of performing maximum likelihood detection (MLD).

The MLD is a method of detecting a vector that maximizes likelihood for a receive signal vector, from among all vector candidates a transmit signal vector may take up. On condition that the precoding is nonlinear precoding, the MLD may be achieved by solution of a minimization problem represented by Expression (7).

$$\begin{matrix}[ Expression 7 ] & \\ {d}_{u , opt} + 2 δ {z}_{t , u , opt} = {arg min}_{{{d}_{u} ∈ {S}^{L}}_{{z}_{t , u} ∈ {C}_{z}^{L}}} {\vert \vert {r}_{u} - {G}_{u} ( {d}_{u} + 2 δ {z}_{t , u} ) \vert \vert}^{2} & ( 7 )\end{matrix}$$

wherein S represents a set of candidate points for a modulation technique applied to data signals. C_{z} represents a set of Gauss integers. The channel compensation unit 407 outputs a vector that satisfies Expression (7). The perturbation terms, however, may be represented by arbitrary Gauss integers, as stated in description on the signal processing in the precoding unit 107 of the base station device 1, and thus it is almost impossible to explore all the candidates for the transmit signal vector. On condition that the nonlinear precoding is carried out, therefore, it is fundamental in the MLD also to limit number of the candidates to be explored.

In order to limit the number of the candidates, it is conceived in the embodiment that hierarchical detection is performed in the MLD. It is conceived that QR decomposition is initially applied to Gᵤ in the channel compensation unit 407 so that Gᵤ is expressed by product of unitary matrix Q and upper triangular matrix R (namely, Gᵤ=QR). Then Expression (7) may be substituted with Expression (8).

$$\begin{matrix}[ Expression 8 ] & \\ \begin{matrix}{d}_{u , opt} + 2 δ {z}_{t , u , opt} = {arg min}_{{{d}_{u} ∈ {S}^{L}}_{{z}_{t , u} ∈ {C}_{z}^{L}}} \vert \vert {Q}^{H} \vert \vert \cdot {\vert \vert {r}_{u} - {G}_{u} ( {d}_{u} + 2 δ {z}_{t , u} ) \vert \vert}^{2} \\ = {arg min}_{{{d}_{u} ∈ {S}^{L}}_{{z}_{t , u} ∈ {C}_{z}^{L}}} {\vert \vert {Q}^{H} {r}_{u} - R ( {d}_{u} + 2 δ {z}_{t , u} ) \vert \vert}^{2} \\ = {arg min}_{{{d}_{u} ∈ {S}^{L}}_{{z}_{t , u} ∈ {C}_{z}^{L}}} {\vert \vert {r}_{u}^{′} - R ( {d}_{u} + 2 δ {z}_{t , u} ) \vert \vert}^{2}\end{matrix} & ( 8 )\end{matrix}$$

wherein Q^{H}rᵤ=rᵤ′ is established. Such transformation makes it possible to detect most likely signals as signal point candidates for x_{u,L}=d_{u,L}+2δz_{t,u,L} without consideration of other data. The detected signals may be also referred to as soft estimates. Once the signal point candidates for x_{u,L} are detected, signal point candidates for x_{u,L-1}=d_{u,L-1}+2δz_{t,u,L-1} may similarly be detected. In case where all the candidate points are explored then, most likely signal candidate points may be detected, while enormous number of explorations are demanded therefor. Consequently, it is demanded to limit the signal point candidates that are to be considered. A method of limiting the signal point candidates is not restricted. Description will be given below on the method based on M-algorithm.

For the signal point candidates for x_{u,L}, initially, candidate points numbering in M are detected in order of nearness to r′_{u,L}. As a method of the detection, it is preferable to calculate |r′_{u,L}−R_{L,L}x_{u,L}|² as metric values and to find the M signal point candidates x_{u,L,1} through x_{u,L,M} in ascending order in the metric value. R_{x,y} therein represents a component on x-th row and y-th column in a matrix R. Though the signal point candidates for x_{u,L} that are to be calculated exist innumerably, number of the candidate points for the perturbation terms is limited to a given value K herein. For the values K and M, optimum values are preferably found in advance by computer simulation or the like.

Subsequently, the signal point candidates for x_{u,L-1} are detected. As is the case with the detection of the candidates for x_{u,L}, |r′_{u,L-1}−(R_{L-1,L-1}x_{u,L-1}+R_{L-1,L}x_{u,L})|² are calculated as metric values. For x_{u,L}, the metric values are respectively found with use of the M candidates that have already been detected. Pairs of the signal point candidates of x_{u,L-1} and x_{u,L} that give M metrics in ascending order of all the found metric values are found. Above processing is iterated until the signal point candidate for x_{u,1} is detected, and signal point candidate that eventually provides a pair of signal point candidates with smallest metric is determined as transmit signal destined for the device itself.

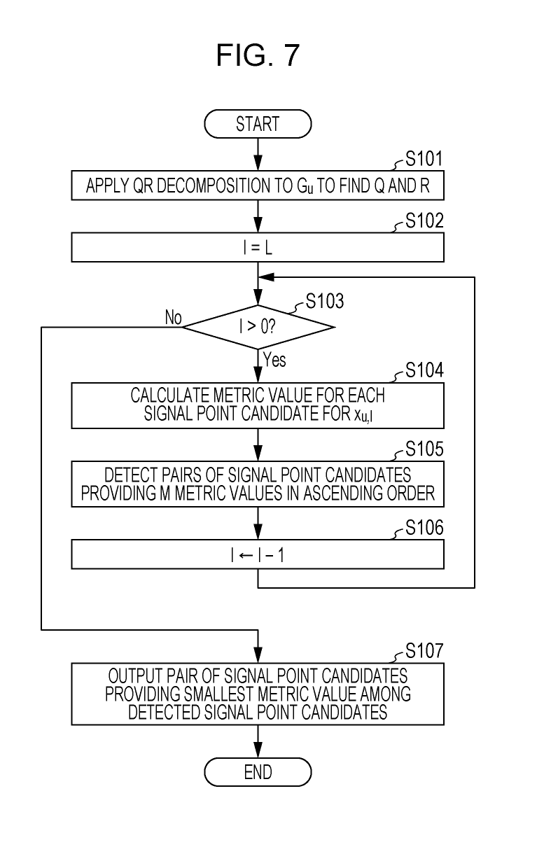

FIG. 7 is a flow chart illustrating the signal processing in the channel compensation unit 407 according to the first embodiment of the invention. Initially, the QR decomposition is applied to Gᵤ and Gᵤ is decomposed into the product of the unitary matrix Q and the upper triangular matrix R (step S101). Subsequently, value of parameter l that controls iterative processing is initialized into L (step S102). If l>0 (step S103: Yes), the metric values for x_{u,l} are calculated in consideration of the signal point candidates that have already been detected (step S104). After that, the pairs of the signal point candidates that number in M are detected in ascending order in the metric values (step S105), the value of the parameter l is decremented (step S106), and the flow returns to step S103. If l=0 (step S103: No), a pair of signal point candidates that provides the smallest metric value among the detected signal point candidates is outputted (step S107).

Though above description has been given on the method based on the M-algorithm, the signal point candidates may be detected by a method based on sphere decoding. In both the methods, the transmission performances greatly depend on accuracy of signal point candidate for d_{u,L}+2δz_{t,u,L} that is initially detected, and thus replacement (ordering) of columns by which R_{L,L} that is lowest component in diagonal components of the upper triangular matrix R is made as large as possible is preferably carried out for Gᵤ in advance. A configuration in which the ordering is carried out afresh after detection of d_{u,L}+2δz_{t,u,L} may be provided.

A configuration is conceivable in which the base station device 1 notifies the terminal devices 3 of the control information associated with the prior probabilities of the perturbation terms. In this configuration, the control information is inputted into the channel compensation unit 407 and may be used for the limitation on the candidate points for the perturbation terms, that is, setting of the value K. For instance, control may be exerted so that perturbation terms for which the prior probabilities have values equal to or lower than a given value may not be explored. On condition that 1-bit information indicating whether the addition of the perturbation terms has been made is notified, particularly, it is preferable to perform the exploration based on Expression (7) if the addition of the perturbation terms has been made and to perform the exploration that is performed in presence of the conventional linear precoding (that is, exploration not considering z_{t,u}) if the addition has not been made.

The prior probabilities may be used for weighting on the likelihood calculated for each candidate point, instead of the limitation on the signal point candidates. On condition that the hierarchical detection is performed, the detection of the signal point candidates for d_{u,L-1}+2δz_{t,u,L-1} is carried out in consideration of the likelihood calculated with the detection of the signal point candidates for d_{u,L}+2δz_{t,u,L}, for instance. For the likelihood for d_{u,L}+2δz_{t,u,L}, the likelihood directly multiplied by the prior probabilities for z_{t,u,L} may be used as new likelihood. By such control, influence of error propagation upon failure in the initial detection of the signal point candidates may be reduced when the hierarchical detection is performed. The weighting on the likelihood may be carried out in any way as long as the prior probabilities are reflected in the weighting.

In case where the prior probabilities for the perturbation terms have not been transmitted from the precoding system of the base station device 1, the terminal devices 3 may preferably perform the signal processing on assumption that the prior probabilities for the perturbation terms are entirely equal. In the terminal devices 3, the prior probabilities for the perturbation terms may separately be calculated and may be used for spatial signal detection. As the perturbation terms that are added in the nonlinear precoding, perturbation terms that make the required transmission power as low as possible are basically selected and added to the transmit data. Accordingly, the perturbation terms that exist in quadrant residing in point symmetrical relation to a quadrant where the signal points of the transmit data exist are added with a high probability. When the signal points of the transmit data are included in first quadrant, for instance, there is a high possibility that the perturbation terms which are added are included in third quadrant. When the candidate points of the transmit data are included in the first quadrant in process of the hierarchical detection, accordingly, control may be made so that perturbation terms included in the third quadrant may be explored in more detail (that is, larger number of the candidates may be provided therein) than perturbation terms included in other quadrants. The weighting on the likelihood may be carried out similarly.

The signal processing in the channel compensation unit 407 in the embodiment has been described above. In the channel compensation unit 407, either the detection based on the linear filtering or the detection based on the MLD may be used and is thus preferably used with switching in accordance with desired transmission performances, permissible complexity, and the like. As a matter of course, a configuration that allows only either detection may be used. When the detection based on the MLD is carried out, the signal detection that makes use of the prior probabilities for the perturbation terms notified from the base station device 1 may be carried out or the prior probabilities may be calculated in the channel compensation unit 407 and may be used for the signal detection in case where the prior probabilities are not notified from the base station device 1.

Output of the channel compensation unit 407 is thereafter inputted into the demapping unit 409. The demapping unit 409 of each terminal device 3 extracts transmit data destined for the terminal device 3 from wireless resources that are used for transmission of the transmit data destined for the terminal device 3. The demapping unit 409 inputs the extracted data into the data demodulation unit 411. The data demodulation unit 411 carries out data demodulation for the inputted data and inputs the data into the channel decoding unit 413. The channel decoding unit 413 carries out channel decoding for the inputted data. Through the above signal processing, the terminal device 3 is capable of acquiring information destined for the terminal device 3 itself. In a configuration, output of the reference signal separation unit 509 may be inputted into the demapping unit 409 first, only the wireless resource components pertaining to the device itself may be inputted into the channel compensation unit 407, and the output of the channel compensation unit 407 may be inputted into the data demodulation unit 411.

The output of the channel compensation unit 407 is then in a state in which the perturbation terms have been added to the transmit data the base station device 1 transmitted to the terminal device 3. As stated in the description on the precoding processing in the base station device 1, the perturbation terms may be removed by the performance of the modulo operation. Therefore, the modulo operation is preferably applied to the inputted signals in the data demodulation unit 411. Signal candidate points the data signals to which the perturbation terms have been added may take up are any of signal points for which signal candidate points for original modulation signals are periodically iterated in a signal point space. The modulo operation detects signal points nearest to the output of the channel compensation unit 407 thereamong. Logarithmic likelihood ratio may be calculated based on distances (likelihood) between the periodically iterated signal points and the output of the channel compensation unit 407 without the performance of the modulo operation. On condition that the data demodulation, the channel decoding, or the like is carried out based on the logarithmic likelihood ratio, the modulo operation may be omitted.

The above description presupposes that the frequency division duplexing using different carrier frequencies for uplink transmission and downlink transmission is used in duplex operation. The embodiment may be directed to wireless communication systems in which time division duplexing that makes use of the same carrier frequency for uplink transmission and downlink transmission is used in duplex operation. In the time division duplexing, the base station device 1 is capable of estimating CSI (CSI stated in Expression (1) in the embodiment) for the downlink transmission from the uplink transmission, whereas phase rotation of signals is caused by heat or the like in analog circuits in the devices. Therefore, an error exists between the CSI the base station device 1 may grasp and actual CSI also in the communication systems in which the time division duplexing is used. The embodiment is also capable of compensating for degradation in performances that is caused in this manner.

Though the OFDM signal transmission is assumed and it is assumed that the precoding is carried out for each sub-carrier in the embodiment, there are no limitations on the transmission scheme (or access scheme), unit for application of the precoding, and the like. For instance, the embodiment may be applied to a configuration in which precoding is carried out for each resource block including a plurality of sub-carriers in a lump and may similarly be applied to access schemes on single-carrier base (such as single carrier-frequency division multiple access (SC-FDMA) scheme).

On condition that the multiple rank transmission to the terminal devices 3 is carried out in downlink MU-MIMO transmission using the nonlinear precoding, the method described above makes it possible to curb residual interference by the specific equivalent channel matrix estimated based on the DMRS. As a result, the degradation in the transmission performances due to the feedback errors may be reduced.

### 2. Second Embodiment

The first embodiment is directed to the MU-MIMO transmission in which a plurality of transmit data are simultaneously transmitted to the terminal devices 3, in which the nonlinear precoding involving the respective addition of the perturbation terms to the transmit data is carried out, and in which the terminal devices 3 perform the spatial signal detection processing based on the specific equivalent channel matrix estimated with use of the DMRSs.

The nonlinear precoding involving the addition of the perturbation terms has an inherent factor in degradation in transmission performances that is called modulo loss. On condition that receive-signal-to-noise power ratio is constant, accordingly, receive signals to which the perturbation terms have not been added are superior in the transmission performances to receive signals to which the perturbation terms have been added. The second embodiment is directed to methods in which influence of the modulo loss is considered.

### [2.1. Base Station Device 1]

A configuration of the base station device 1 according to the second embodiment is the same as that in FIG. 2. Signal processing in the precoding units 107, however, differs from that of the first embodiment and thus will be described below.

Configuration of the precoding unit 107 is the same as that in FIG. 3 but signal processing in the perturbation vector exploration unit 203 differs. In the first embodiment, the exploration for the perturbation terms is carried out on assumption that the perturbation terms may be added to any of the data signals. In the second embodiment, limitations are imposed on data signals to which the perturbation terms may be added.

Specifically, the perturbation terms are not added to data signals numbering in M among data signals numbering in L that are simultaneously transmitted to each terminal device 3. Each terminal device 3 carries out the ordering for the specific equivalent channel matrix so that the data signals to which the perturbation terms have not been added are subjected first to signal detection. This may reduce the influence of the error propagation caused by failure in the detection when the hierarchical spatial signal detection is performed. Several methods are conceivable as a method of selecting the data signals numbering in M to which the perturbation terms are not added.

In first method, the data signals to which the perturbation terms are not added are fixed. On condition that a plurality of transmit data are transmitted to the terminal devices 3, there is a necessity for the base station device 1 to notify the terminal devices 3 of order of transmission of the data signals. As the method of the notification, there is a method in which control is made with use of information referred to as antenna port number. In the first embodiment, for instance, the data signals destined for the u-th terminal device 3-u are expressed by the vector dᵤ=[d_{u,1}, . . . , d_{u,L}]^{T}. In description using the antenna port number, d_{u,1} may be expressed as being transmitted by antenna port 1 and d_{u,L} may be expressed as being transmitted by antenna port L. Commonly, relation between the antenna port numbers and the order of the transmission of the data signals is determined in advance between the base station device 1 and the terminal devices 3. Providing that the base station device 1 notifies each terminal device 3 of the antenna port numbers that are used, accordingly, each terminal device 3 is capable of acquiring the transmit data destined for the terminal device 3 itself.

In the first method in which control may be exerted so that the perturbation terms are not added for the antenna port 1 through the antenna port L′, consequently, the terminal devices 3 may perform signal processing on assumption that the perturbation terms have not been added to the signals transmitted through the antenna port 1 through the antenna port L′. The base station device 1 preferably notifies the terminal devices 3 of only value of L′. Providing that the value of L′ is determined in advance, notification of L′ is not demanded.

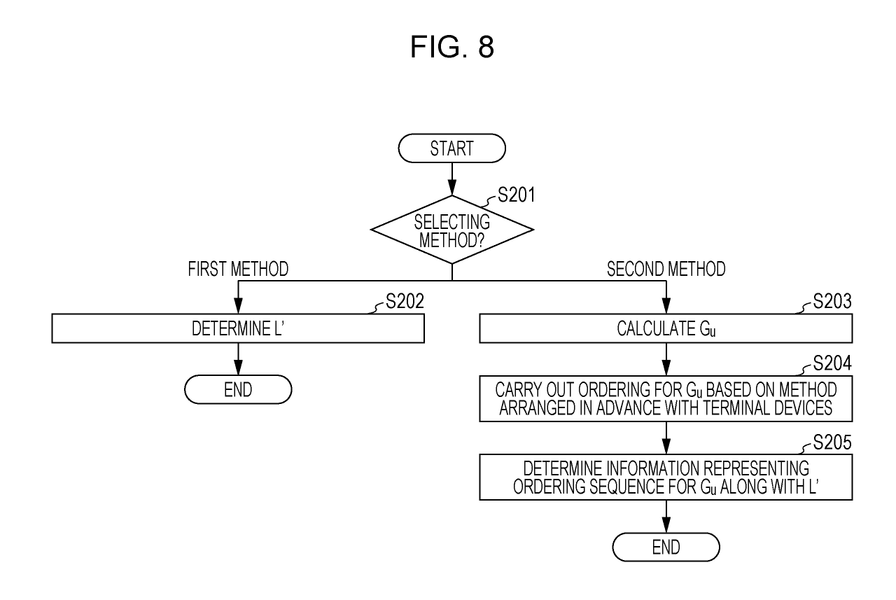

In second method, the data signals to which the perturbation terms are not added are determined on supposition of ordering processing the terminal devices 3 apply to the specific equivalent channel matrix. It has already been stated that detection accuracy is increased by the ordering performed for the specific equivalent channel matrix on condition that the channel compensation unit 407 of the terminal device 3 uses the MLD, involving hierarchical estimation, as the spatial signal detection processing. The base station device 1 is capable of grasping the specific equivalent channel matrix. Accordingly, the base station device 1 is capable of grasping what ordering each terminal device 3 carries out. Therefore, the base station device 1 preferably performs the ordering for the specific equivalent channel matrix for each terminal device 3 and preferably exerts the control so that the perturbation terms are not added to L′ elements of transmit data disposed at end of a transmit data vector having undergone the ordering. Then it is demanded to predetermine criterion for the ordering between the base station device 1 and the terminal devices 3. Providing that the terminal devices 3 carry out the ordering for the specific equivalent channel matrix based on the predetermined criterion, it is made possible to perform the detection from the data signals to which the perturbation terms have not been added. In this process, the base station device 1 preferably notifies the terminal devices 3 of only the value of L′. Providing that the value of L′ is determined in advance, the notification of L′ is not demanded, as is the case with the first method. The methods, described above, of selecting the data signals to which the perturbation terms are not added will be described with use of FIG. 8.

FIG. 8 is a flow chart illustrating signal processing for determining the data signals to which perturbation terms are not added that is performed in the perturbation vector exploration unit 203 of the precoding unit 107 according to the second embodiment of the invention. Initially, the selecting method is determined (step S201). When the selection is based on the first method (step S201: first method), only number L′ of the data to which the perturbation terms are not added is outputted (step S202) and processing is ended. When the selection is based on the second method (step S203: second method), the specific channel matrix Gᵤ for each terminal device 3 is initially calculated (step S204), the ordering processing is carried out for Gᵤ based on the method arranged in advance with the terminal devices 3, and information (such as permutation matrix) representing sequence of the ordering is calculated (step S205). Then the number L′ of the data to which the perturbation terms are not added and the information representing the sequence of the ordering are outputted and the processing is ended.

Based on the methods described above, the perturbation vector exploration unit 203 of the precoding unit 107 determines the data signals to which the perturbation terms are not added. Under this condition, the perturbation terms that may minimize the required transmission power are explored for. An actual method of exploring for the perturbation terms is the same as that in the first embodiment except that the data signals to which the perturbation terms are not added are regarded as receiving addition of zero as the perturbation terms at all times.

In the precoding unit 107, after that, the transmit signal generator unit 205 generates a transmit signal vector based on the perturbation terms outputted from the perturbation vector exploration unit 203 and outputs the transmit signal vector as output of the precoding unit 107. There is a necessity that the base station device 1 notifies afresh the terminal devices 3 of the method of selecting the data signals to which the perturbation terms are not added and L′ indicating the number of the data to which the perturbation terms are not added, as the control information. In addition to the transmit signal vector, the control information is inputted into the wireless transmitter unit 305 in the antenna unit 109 and is transmitted toward each terminal device 3.

Though the plurality of methods have been described as the method of determining the data signals to which the perturbation terms are not added, the control may be exerted so that one method may always be used or so that the plurality of methods may optionally be used. On condition that the plurality of methods are optionally used, there is a necessity for the base station device 1 to notify the terminal devices 3 of the method that is used.

### [2.2. Terminal Device 3]

Configuration of the terminal devices 3 is the same as that in FIG. 5 and the signal processing that is performed in each device is the same except for signal processing in the channel compensation unit 407. Hereinbelow, only the signal processing in the channel compensation unit 407 will be described.

The signal processing in the channel compensation unit 407 differs from that of the first embodiment in the method of the ordering for the specific equivalent channel matrix Gᵤ. When the QR decomposition is applied to Gᵤ in the first embodiment, the ordering is carried out so that end of the diagonal components of the upper triangular matrix R may be made as large as possible. In the second embodiment, the ordering is carried out so that the transmit data to which the perturbation terms have not been added are subjected first to the signal detection, as stated in the description on the precoding.

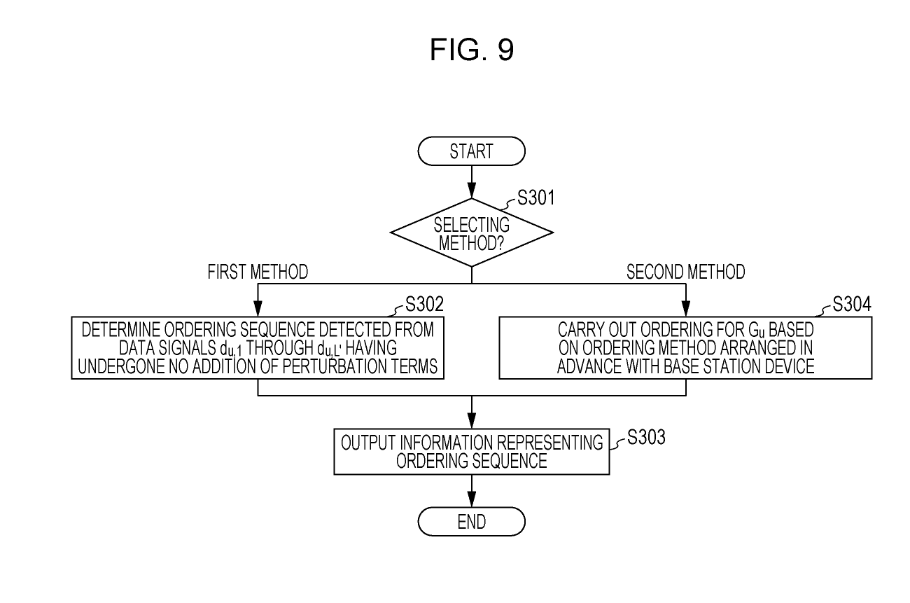

FIG. 9 is a flow chart illustrating ordering processing for the specific channel matrix Gᵤ in the channel compensation unit 407 according to the second embodiment of the invention. When the first method is used as the method of selecting the data signals to which the perturbation terms are not added that is performed in the base station device 1 (step S301: first method), the ordering is carried out for Gᵤ so that any of the data signals d_{u,1} through d_{u,L′} to which the perturbation terms have not been added may come to lowest (step S302). In the detection using the hierarchical MLD based on the M-algorithm described for the first embodiment, specifically, the ordering is carried out so that the data signals d_{u,1} through d_{u,L′} may be subjected first to the detection of the signal point candidates. After that, information representing sequence of the ordering is outputted (step S303) and the processing is ended. When the second method is used in the base station device 1 (step S301: second method), the ordering is carried out for the specific channel matrix based on an ordering method arranged in advance with the base station device 1 (step S304), the information representing the sequence of the ordering is outputted (step S303), and the processing is ended.

The hierarchical detection is preferably performed based on the ordering sequence determined as described above and the detection of the transmit data is carried out on assumption that the perturbation terms have not been added to data signals ranging from initially detected data signal to L′. That is, the detection is preferably performed on assumption that zero is added as the perturbation terms to the transmit data at all times.

The signal processing the channel compensation unit 407 of each terminal device 3 performs in the second embodiment has been described above. Though the above description is chiefly directed to the MLD in which the QR decomposition is used as the hierarchical detection, other hierarchical detection methods may be used instead.

As other hierarchical detection method, there is successive interference canceller (SIC). In this method, initially, detection of one of a plurality of transmit data, that is, obtainment of a soft estimate is attained by the spatial filtering. Then a signal replica calculated from the detected soft estimate and the specific equivalent channel matrix is subtracted from receive signals not yet subjected to the spatial filtering, and the spatial filtering is carried out afresh. As a basic concept of the SIC, the above signal processing is iterated until soft estimates of all the transmit data are detected.

In the SIC, accuracy of the signal replica calculated from the initially detected soft estimate greatly influences transmission performances. Accordingly, the signal replica is normally produced from a soft estimate that maximizes receive-signal-to-interference plus noise power ratio. On condition that the spatial signal detection is performed with use of the SIC in the embodiment, the detection is preferably performed from soft estimates associated with the transmit data to which the perturbation terms have not been added.

In the hierarchical detection, the accuracy of data detection may further be increased after detection of all the transmit data and by another performance of the detection based on results of the former detection. A series of detection may infinitely be iterated and thus such detection is referred to as iterative signal detection. In this process, results of channel decoding for the detected transmit data may be used for subsequent signal detection. When the channel decoding is carried out in this method, accuracy of signal detection may further be increased by the channel decoding in consideration of presence or absence of the addition of the perturbation terms to the transmit data. The consideration of the presence or absence of the addition of the perturbation terms during the channel decoding is effective for improvement in the transmission performances, regardless of a method of the spatial signal detection processing.

For the embodiment, the method of the precoding and the method of the spatial signal detection processing that are intended for reducing the degradation in the transmission performances due to the modulo loss have been clarified. In the methods of the embodiment, the influence of the modulo loss may be curbed without radical increase in overhead.

### 3. All Embodiments

Though the embodiments of the invention have been described above in detail with reference to the drawings, specific configurations are not limited to the embodiments and designs and the like in a scope not departing from purport of the invention are encompassed by the claims.

Programs that run in mobile station devices and the base station device 1 relating to the invention are programs (programs that make computers function) for controlling CPUs and the like so as to attain functions of the embodiments relating to the invention. Information handled in those devices is temporarily accumulated in RAMS during processing of the information, thereafter stored in various ROMs and/or HDDs, and subjected by the CPUs to reading, modification, and/or writing as appropriate. Recording media in which the programs are stored may be any of semiconductor media (such as ROM and nonvolatile memory card), optical recording media (such as DVD, MO, MD, CD, and BD), magnetic recording media (such as magnetic tape and flexible disk), and the like. Not only are the functions of the embodiments described above attained by execution of the loaded programs, but the functions of the invention may be attained by processing in cooperation with operating system, other application programs, and/or the like based on instructions from the programs.

For circulation on the market, the programs stored in portable recording media may be circulated or may be transferred to server computers connected through networks such as the Internet. In such configurations, storage devices of the server computers are encompassed by the invention. Portions or all of the mobile station devices and the base station device 1 in the embodiments described above may be implemented as LSIs that are integrated circuits, typically. Functional blocks of the mobile station devices and the base station device 1 may individually be configured into processors or portions or all of the functional blocks may be integrated and configured into processors. Technique of the configuration as integrated circuits may be achieved by use of dedicated circuits or general-purpose processors without limitation to LSI. Providing that technologies of the configuration as integrated circuits that are alternatives to LSI are developed with progress in semiconductor technology, integrated circuits based on the technologies may be used.

### REFERENCE SIGNS LIST

1 base station device
3, 3-1 to 3-4 terminal device
101 channel coding unit
103 data modulation unit
105 mapping unit
107 precoding unit
109 antenna unit
111 control information acquisition unit
113 channel state information acquisition unit
115 control information generator unit
201 linear filter generator unit
203 perturbation vector exploration unit
205 transmit signal generator unit
301 IFFT unit
303 GI insertion unit
305 wireless transmitter unit
307 wireless receiver unit
309 antenna
401 terminal antenna unit
403 channel estimation unit
405 feedback information generator unit
407 channel compensation unit
409 demapping unit
411 data demodulation unit
413 channel decoding unit
415 spatial demultiplexing processing unit
501 wireless receiver unit
503 wireless transmitter unit
505 GI cancellation unit
507 FFT unit
509 reference signal separation unit

1-13. (canceled)

14. A wireless reception device that includes a plurality of antennas and that receives wireless signals having undergone nonlinear precoding and spatial multiplexing from a wireless transmission device, the wireless reception device comprising:
a channel estimation unit that is configured to estimate a channel state to and from the wireless transmission device and to output channel state information, based on first reference signals, and to estimate the channel state to and from the wireless transmission device and to output specific equivalent channel state information, based on second reference signals having undergone a portion of the nonlinear precoding;
a spatial demultiplexing processing unit that is configured to acquire information indicating prior probabilities for perturbation terms added to transmit data by the nonlinear precoding in the wireless transmission device and to calculate soft estimates for the transmit data based on the acquired information indicating the prior probabilities and the specific equivalent channel state information; and
a wireless transmitter unit that is configured to transmit the channel state information, estimated based on the first reference signals, to the wireless transmission device.

15. The wireless reception device according to claim 14,
wherein the spatial demultiplexing processing unit acquires the information indicating the prior probabilities based on a quadrant in a complex plane that includes signal candidate points for the transmit data to which the perturbation terms have been added.

16. The wireless reception device according to claim 14,
wherein the spatial demultiplexing processing unit acquires the information indicating the prior probabilities based on control information associated with the prior probabilities notified from the wireless transmission device.

17. The wireless reception device according to claim 14,
wherein the spatial demultiplexing processing unit determines order of calculation of the soft estimates for the transmit data, based on the information indicating the prior probabilities for the perturbation terms.

18. The wireless reception device according to claim 14,
wherein the spatial demultiplexing processing unit performs spatial filtering in which a receive signal vector is multiplied by a linear filter calculated based on the specific equivalent channel state information and demodulates desired signals from the received wireless signals.

19. A wireless transmission device that includes a plurality of antennas and that transmits data signals destined for a plurality of wireless reception devices while applying spatial multiplexing to the data signals, the wireless transmission device comprising:
a channel state information acquisition unit that is configured to acquire from each of the wireless reception devices channel state information generated in each of the wireless reception devices based on first reference signals transmitted to each of the wireless reception devices;
precoding units that are configured to apply nonlinear precoding to the data signals, based on the acquired channel state information and to apply a portion of the nonlinear precoding to second reference signals;
a control information generator unit that is configured to generate control information indicating prior probabilities for perturbation terms which are added to the data signals by the nonlinear precoding; and
a wireless transmitter unit that is configured to transmit the data signals, the first reference signals, the second reference signals, and the control information indicating the prior probabilities to each of the wireless reception devices.

20. An integrated circuit that is mounted in a wireless reception device which includes a plurality of antennas and which receives wireless signals having undergone nonlinear precoding and spatial multiplexing from a wireless transmission device and that thereby makes the wireless reception device perform a plurality of functions, the integrated circuit configured to make the wireless reception device perform a series of functions comprising:
a function of estimating a channel state to and from the wireless transmission device and outputting channel state information, based on first reference signals;
a function of estimating the channel state to and from the wireless transmission device and outputting specific equivalent channel state information, based on second reference signals having undergone a portion of the nonlinear precoding; and
a function of acquiring information indicating prior probabilities for perturbation terms added to transmit data by the nonlinear precoding in the wireless transmission device and calculating soft estimates for the transmit data based on the acquired information indicating the prior probabilities and the specific equivalent channel state information.
